(19) United States
(12) Patent Application Publication
(10) Pub. No.: US 2004/0014367 A1
(43) Pub. Date: Jan. 22, 2004

(54) Telecommunications connector adapted for bi-directional insertion

(76) Inventor: Cyle D. Petersen, Belle Plaine, MN (US)

Correspondence Address: MERCHANT & GOULD PC, P.O. BOX 2903, MINNEAPOLIS, MN, 55402-0903, US

(21) Appl. No.: 10/199,986

(22) Filed: Jul. 19, 2002

(51) Int. Cl. H01R 24/04

(52) U.S. Cl. 439/669

(57) ABSTRACT

The present disclosure relates to a connector having a connector body. A housing mounts over the connector body. The housing is adapted for securing the connector to another element such as a piece of telecommunications equipment. The housing is insertable from either a forward or a rearward direction.

### FIELD OF THE INVENTION

The present invention relates generally to electrical connectors. More particularly, the present invention relates to telecommunications connectors.

### BACKGROUND OF THE INVENTION

In the telecommunications industry, connectors are used to interconnect cables to pieces of telecommunications equipment or to other circuitry (e.g., switches). U.S. Pat. No. 5,913,701, which is incorporated herein by reference, shows connectors 60 and 60′ mounted to the back wall of a digital cross-connect (DSX) module. In addition to modules, connectors are also frequently mounted to other structures such as telecommunications panels, frames, chassis, PC boards or other structures.

### SUMMARY

The present disclosure describes representative embodiments that include examples of how several different inventive concepts can be practiced. It will be appreciated that the inventive concepts can be used together or separately from one another. It will further be appreciated that the examples embodying the inventive concepts are merely illustrative, and that variations can be made with respect to the depicted examples without departing from the broad scope of the inventive concepts.

An example embodiment disclosed herein relates to a telecommunications connector adapted for connection to a piece of telecommunications equipment. The connector includes a connection structure that allows the connector to be mounted to the telecommunications equipment by inserting the connector from either a forward or a rearward direction.

### BRIEF DESCRIPTION OF THE DRAWINGS

The accompanying drawings, which are incorporated in and constitute a part of the specification, illustrate various embodiments that are examples of how certain inventions can be put into practice. A brief description of the drawings is as follows:

FIG. 1 is an exploded, perspective view of a connector including features that are examples of how inventive concepts disclosed herein can be practiced;

FIG. 2 is an assembled, perspective view of the connector of FIG. 1;

FIG. 3 is cross-sectional view of the connector of FIG. 2 taken along a plane that bisects the connector;

FIG. 4 illustrates several of the connectors of FIG. 1 connected to a telecommunications panel;

FIG. 5 is a partial cross-sectional view illustrating one of the connectors of FIG. 5 mounted within the telecommunications panel;

FIG. 6 is a perspective view of an alternative connector including features that are examples of how inventive concepts disclosed herein can be practiced;

FIG. 7 is a perspective view of a housing of the connector of FIG. 6;

FIG. 8 is a front view of the housing of FIG. 7; and

FIG. 9 is an exploded view of the connector of FIG. 6.

### DETAILED DESCRIPTION

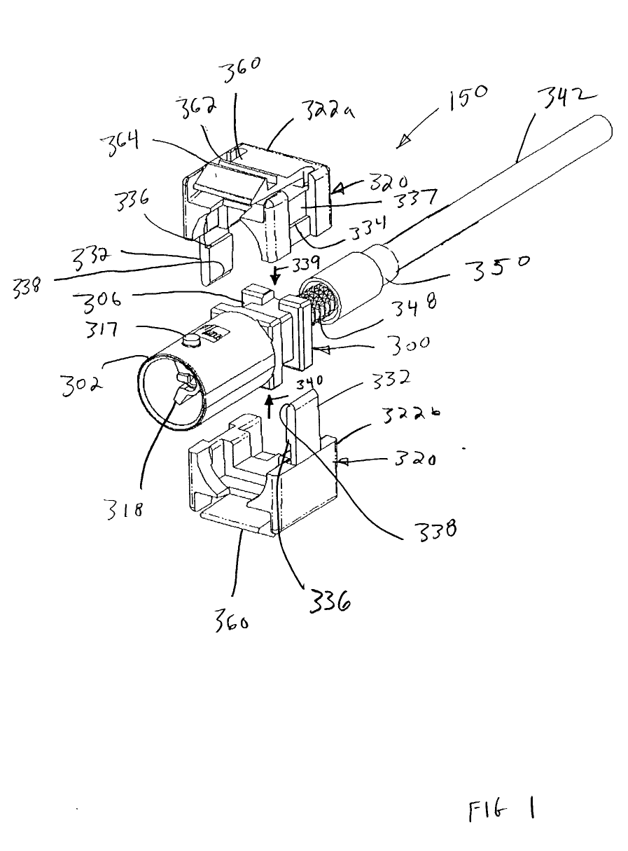

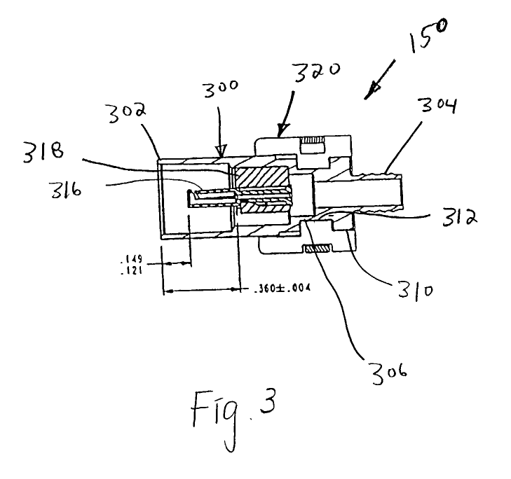

FIGS. 1-3 illustrate a connector 150 having features that are examples of how various inventive concepts disclosed herein can be practiced. The connector 150 includes a bulkhead 300 and a center conductor 316 (shown in FIG. 3) supported within the bulkhead 300. The bulkhead 300 can also be referred to as a “conductor support” since it functions to hold the conductor 316, or a “connector body.” A housing 320 mounts about the bulkhead 300. As will be described below, the housing 320 includes structure for securing the connector 150 to a piece of telecommunications equipment or other structure.

Referring to FIG. 3, the bulkhead 300 of the connector 150 includes a connector sleeve 302 and a crimp-supporting sleeve 304. The sleeves 302, 304 are positioned at opposite ends of the bulkhead 300. The connector sleeve 302 is configured to provide a connection with a BNC type connector (Bayonet Normalized Connector). It will be appreciated that the sleeve can have different configurations to correspond to different styles of connectors such as TNC connectors (Threaded Normalized Connectors, or 1.6/5.6 style connectors). The crimp-supporting sleeve 304 includes structure for enhancing a crimp (e.g., knurling, ridges, surface roughness, bumps, etc.).

The center conductor 316 of the connector 150 preferably mounts within the connector sleeve 302. A dielectric spacer 318 is provided for centering the center conductor 316 within the connector sleeve 302. When a BNC conventional connector (not shown) is coupled to the connector 150, a center pin of the BNC connector fits within center conductor 316, an outer conductor sleeve presses within the sleeve 302, and a twist collar receives tabs 317 of the bulkhead 300 to lock the connectors together. The sleeve 304 is hollow for receiving a cable terminated to the center conductor 316.

The bulkhead 300 also includes a housing mount 306 positioned between the sleeves 302, 304. Preferably the housing mount 306 is integrally or unitarily formed as a single piece with the bulkhead 300. In one embodiment, the bulkhead 300 is constructed of a metal material such as zinc die cast alloy. However, it will be appreciated that other material can also be used.

The housing 320 of the connector 150 includes housing pieces 322a, 322b. To promote manufacturing efficiency, it is preferred for the housing pieces 322a, 322b to have identical configurations. In other embodiments, the housing pieces need not be identical. Further, in still other embodiments, more than two pieces can be provided, or the housing can be formed as a single, integral piece about the bulkhead 300. In one embodiment, the housing 320 is made of a dielectric plastic material such as polycarbonate.

The housing pieces 322a, 322b preferably have internal configurations that complement the outer configuration of the housing mount 306. The housing pieces 322a, 322b are also provided with structure for snap-fitting the pieces together. For example, the housing pieces 322a, 322b are also provided with resilient cantilever arms 332 (i.e. latches) and retaining shoulders 334. As shown in FIG. 1, the cantilever arms 332 and the retaining shoulders 334 are positioned on opposite sides of each housing piece 322a, 322b. Each cantilever arm 332 includes a free end including a retaining tab 336. The retaining tabs 336 are shown including ramp surfaces 338. The retaining shoulders 334 are preferably positioned within exterior slots 337 that are generally parallel with respect to the resilient cantilever arms 332.

To mount the housing 320 on the bulkhead 300, the housing piece 322a is inserted downwardly over the housing mount 306 as shown by arrow 339 in FIG. 1, and the housing piece 322b is inserted upwardly over the housing mount 306 as indicated by arrow 340 in FIG. 1. When the housing pieces 322a, 322b are pushed together, the resilient cantilever arms 332 flex outwardly, with the assistance of ramp surfaces 338, as the retaining tabs 336 enter the exterior slots 337. When the retaining tabs 336 move past the retaining shoulders 334, the inherent elasticity of the cantilever arms 332 causes the cantilever arms 332 to snap into a locked position. In the locked position, the retaining tabs 336 oppose or engage the retaining shoulders 334 to prevent the housing pieces 332a, 332b from being disconnected. If it is desired to disconnect the housing pieces 332a, 332b, the cantilever arms 332 can be manually flexed in an outward direction thereby allowing the housing pieces 322a, 322b to be pulled apart.

As used herein, the phrase “snap-fit connection” means a connection provided by a resilient member that flexes or deforms past a retaining structure and moves to a locking or retaining position by the inherent flexibility or elasticity of the resilient member. In the above described embodiment, the arms 332 move or “snap” past the shoulders 334 by the inherent bias of the arms 332. The term snap-fit connection is not limited to resilient arms, but includes any structure (e.g., bumps, tabs, shoulders, etc.) that are deformed during insertion and move to a retaining position by the inherent elasticity of the structures. In other embodiments, the housing pieces 322a, 322b can be coupled together by other types of connection techniques such as press-fit connections or adhesive connections.

The complementary relationship between the interior of the housing 320 and the housing mount 306 of the bulkhead 300 is preferably configured to prevent relative rotation between the housing 320 and the bulkhead 300. The complementary shape of the interior of the housing 320 and housing mount 306 also prevents the housing 320 from being axially slid from the bulkhead 300.

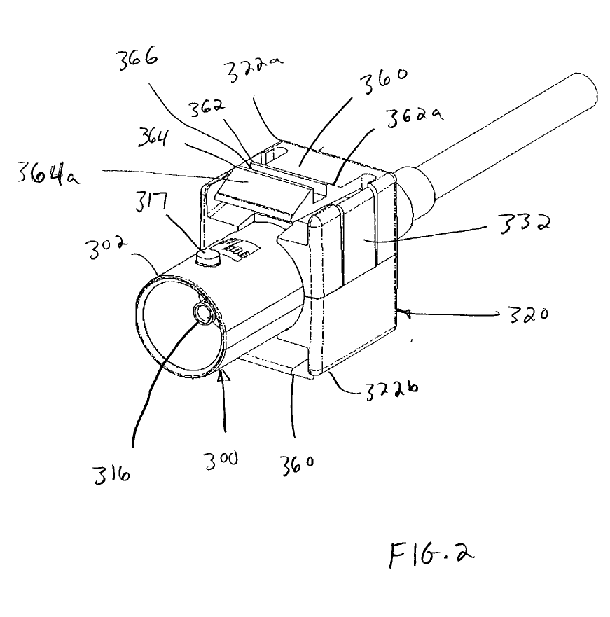

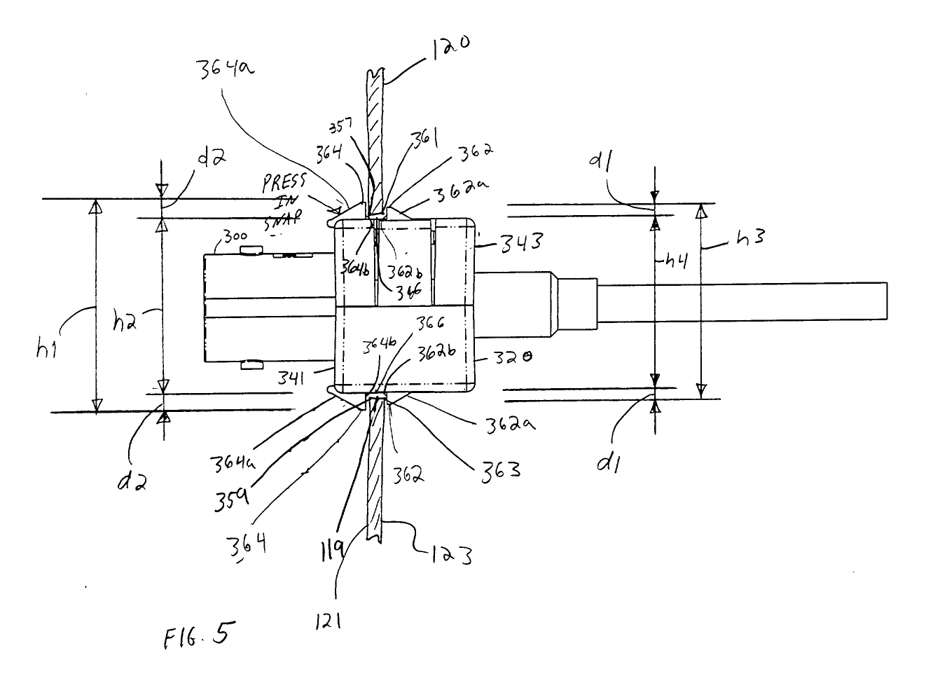

The housing 320 of the connector preferably includes structure for providing a snap-fit connection between the connector 150 and a piece of telecommunications equipment (e.g., a jack module or a panel such as panel 120 shown in FIG. 5). As shown in FIGS. 1, 2 and 5, the housing 320 includes top and bottom resilient cantilever arms 360. As best shown at FIG. 2, each cantilever arm 360 includes first and second retaining tabs 362 and 364 that are separated by a gap 366. The second tab 364 is located at the free end of the arm 360, and the first tab 362 is located between the second tab 364 and the base end of the arm 360. The first tab 362 includes a ramp surface 362a and the second tab 364 includes a ramp surface 364a. As best shown in FIG. 5, the ramp surfaces 362a and 364a converge as the ramp surfaces extend toward the gap 366. For example, as shown in FIG. 5, the surfaces 362a, 364a of the upper arm 360 both angle upwardly as the surfaces 362a, 364a extend toward their corresponding gap 366, and the surfaces 362a, 364a of the lower arm 360 both angle downwardly as the surfaces 362a, 364a extend toward their corresponding gap 366.

Referring still to FIG. 5, the tabs 362, 364 include opposing retaining surfaces 362b and 364b that define side walls of the gap 366. The retaining surface 362b has a smaller vertical dimension d1 than a vertical dimension d2 of the retaining surface 364b. As shown in FIG. 5, the top and bottom tabs 364 define a height h1 that is greater than a height h2 defined at a front end 341 of the housing 320. Preferably, the height h1 is greater than any other height defined between the tabs 364 and the front end 341 of the housing 320. The top and bottom tabs 362 define a height h3 that is greater than a height h4 defined at a rear end 343 of the housing 320. Preferably, the height h3 is greater than any other height defined between the tabs 362 and the rear end 343 of the housing 320, but is smaller than the height h1. As described below, this configuration allows the connector 150 to be inserted into a mounting location from either a forward or a rearward direction.

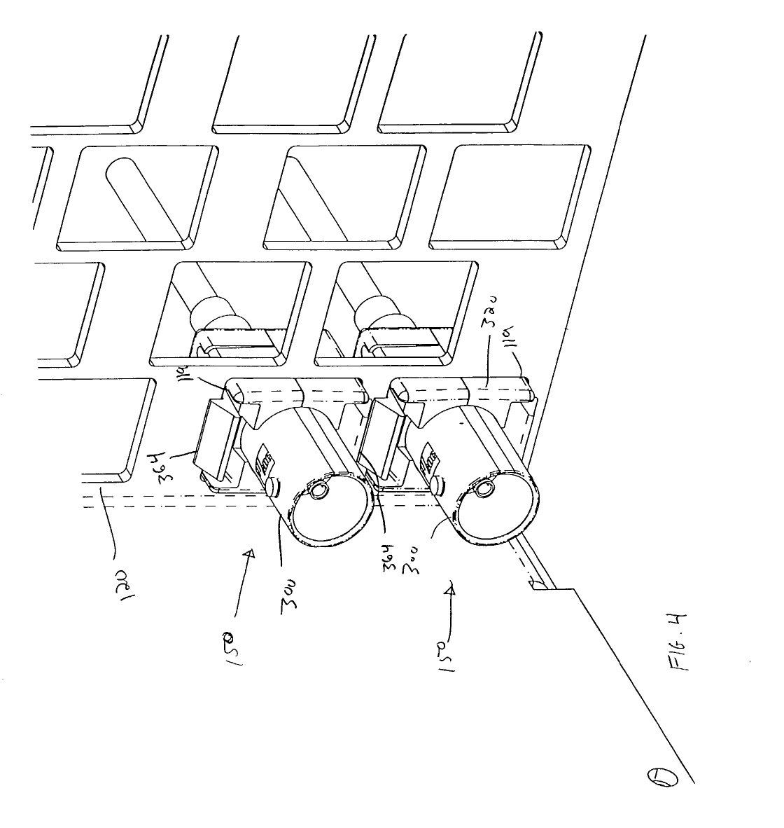

Referring to FIGS. 4 and 5, the connector 150 is adapted to be mounted in an opening 119 defined by a piece of telecommunications equipment such as panel 120. Referring to FIG. 5, the connector 150 can be inserted into the opening 119 from either a front side 121 or a rear side 123 of the panel 120. To mount the connector 150 from the front side 121, the rear end 343 of the connector 150 is inserted in a rearward direction through the opening 119. As the connector 150 is pushed through the opening 119, the ramped surfaces 362a of tabs 362 engage upper and lower front edges 357, 359 of the opening 119 causing the arms 360 to flex inwardly toward one another. Once the tabs 362 move completely through the opening 119, the cantilever arms 360 snap outwardly by their inherent elasticity such that the panel 120 is trapped within the gap 366 between the retaining surfaces 362b, 364b of the tabs 362, 364. As so positioned, the retaining surface 364b engages or opposes the front side 121 of the panel 120, and the retaining surface 362b engages or opposes the rear side 123 of the panel 120. By flexing the cantilever arms inwardly while pushing the connector 150 in either a forward or rearward direction, the connector 150 can be removed from the opening 119.

To mount the connector 150 from the rear side 123, the front end 341 of the connector 150 is inserted in a forward direction through the opening 119. As the connector 150 is pushed through the opening 119, the ramped surfaces 364a of tabs 364 engage upper and lower rear edges 361, 363 of the opening 119 causing the arms 360 to flex inwardly toward one another. Once the tabs 364 move completely through the opening 119, the cantilever arms 360 snap outwardly by their inherent elasticity such that the panel 120 is trapped within the gap 366 between the retaining surfaces 362b, 364b of the tabs 362, 364. As so positioned, the retaining surface 364b engages or opposes the front side 121 of the panel 120, and the retaining surface 362b engages or opposes the rear side 123 of the panel 120.

In the depicted embodiment, the top and bottom sides of the housing are shown having identical configurations. However, in other embodiments, different snap-fit configurations can be provided on the top and bottom sides of the connector. Further, in some embodiments, only one snap-fit structure may be provided. It will be appreciated that the snap-fit structure could be provided on the top, the bottom or either side of the housing 320. Moreover, while the tabs 362, 364 are depicted on the same cantilever arms, the tabs could also be provided on separate cantilever arms. Further, other snap fit structures (e.g., bumps, shoulders, projections, etc.) separated by a gap could also be used.

It will be appreciated that a cable (e.g., a coaxial cable) is preferably terminated to the connector 150. To terminate a cable 342 (shown in FIG. 1) within the connector 150, the cable 342 is preferably stripped. In the stripped configuration, the cable 342 includes an exposed central wire and an exposed reinforcing braid 348. The exposed wire is preferably crimped within the center conductor 316. The center conductor 316 is positioned within the bulkhead 300 of the connector 150 as shown in FIG. 3. To mechanically secure the cable 342 to the connector 150, the braided portion 348 is inserted over the crimp-supporting sleeve 304 of the bulkhead 300 as shown in FIG. 1. A ferrule 350 is then crimped over the braid 348 to affix the braided portion 348 to the sleeve 304.

A connector having a similar bulkhead as the one shown herein is disclosed in U.S. application Ser. No. (not yet assigned) entitled Telecommunications Connector, which has attorney docket No. 2316.1365US01 and was filed on a date concurrent herewith, and which is hereby incorporated by reference in its entirety.

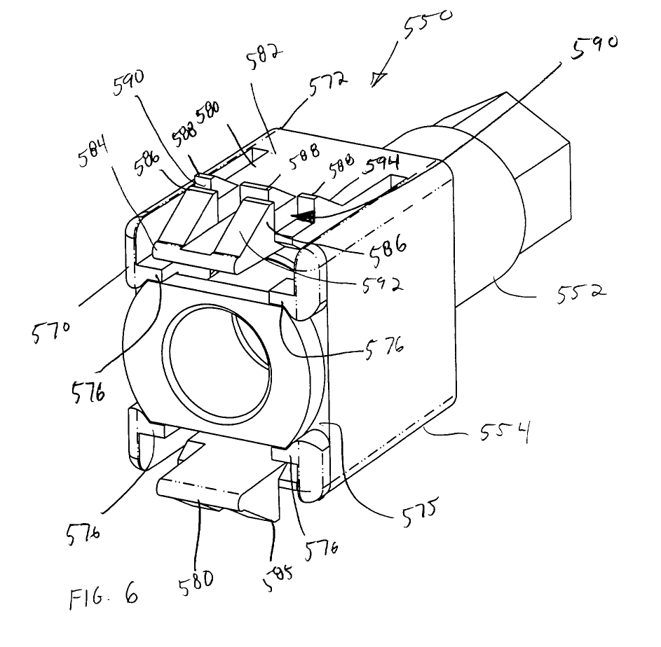

FIG. 6 illustrates an alternative connector 550 having features that are examples of a variety of different inventive concepts. The connector 550 includes a connector body 552 that mounts within a housing 554. The connector body 552 is adapted to be coupled with a connector such as a miniature DSX style 75 ohm coaxial connector. Of course, other connector styles could also be used.

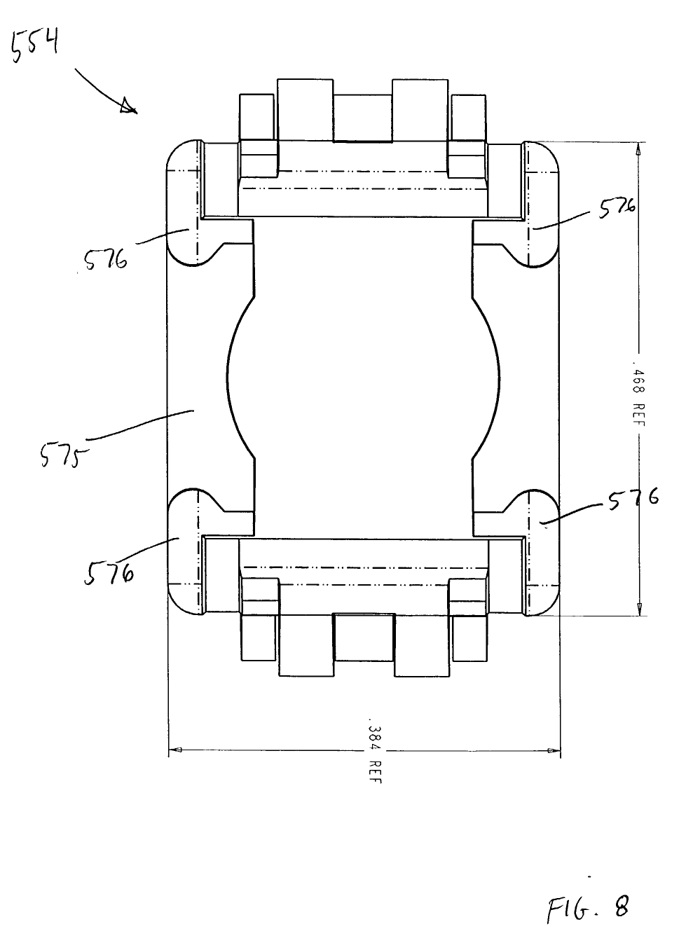

Referring to FIGS. 6-8, the housing 554 is depicted as a unitary structure that is preferably molded as a single piece unit. In one embodiment, the housing is molded from a plastic material such as polycarbonate. The housing 554 includes a front end 570 positioned opposite from a rear end 572. The front end 570 includes a front wall 575, and retaining members 576 that project forwardly from the front wall. The front face of the front wall 570 and the retaining members 576 cooperate to define a pocket 578 located at the front end 570 of the housing 554.

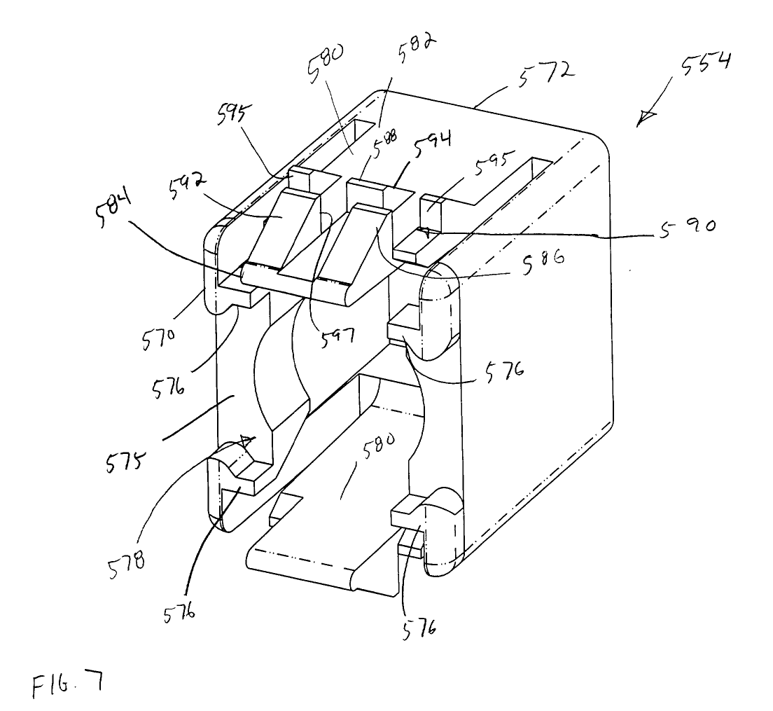

Referring still to FIGS. 6-8, the housing 554 includes integral snap-fit latches 580 located on opposite sides of the housing 554. Each latch 580 includes a base end 582 that is integral within the housing 554, and a free end 584 positioned adjacent the front end 570 of the housing 554. The latches 580 each include sets of front and rear retaining tabs 586 and 588 separated by a gap 590. The tabs 586, 588 include retaining walls 595, 597 (labeled on FIG. 7) that face in opposite directions. The walls 595, 597 extend transversely outwardly from the housing 554 and cooperate to define front and rear walls of the gaps 590. The front retaining tabs 586 include ramp surfaces 592, and the rear retaining tabs 588 include ramp surfaces 594. The ramp surfaces 592, 594 angle outwardly from the housing 554 as the surfaces 592 extend toward the gap 590. Similar to the previous embodiment, the latches 580 allow the housing 554 to be bi-directionally snap fit within an opening defined by a piece of telecommunications equipment.

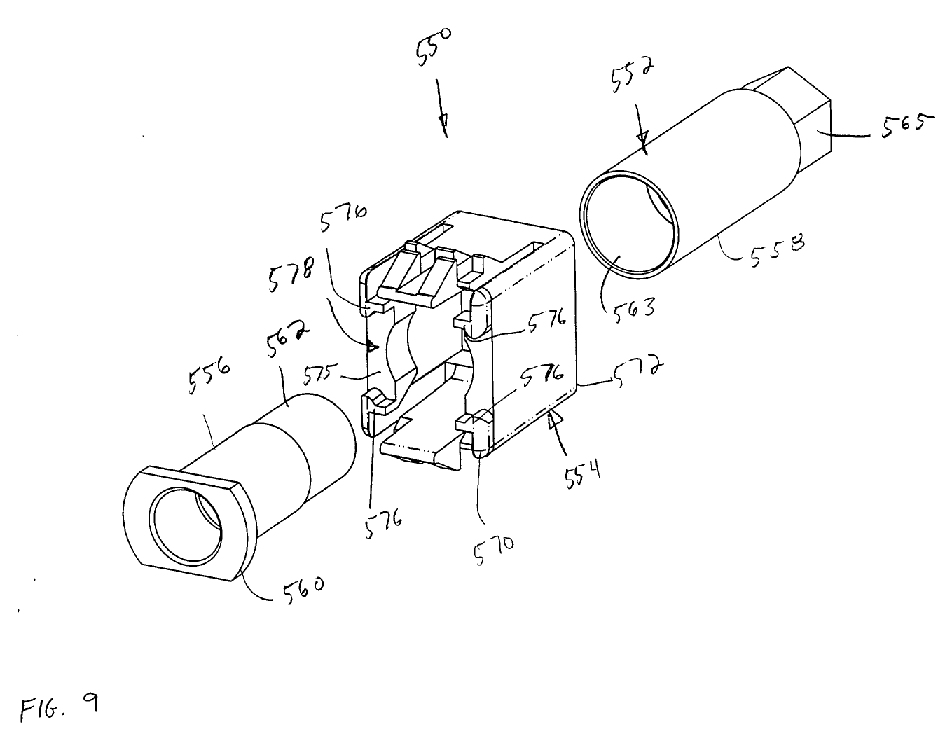

Referring to FIG. 9, the connector body 552 includes a front piece 556 and a rear piece 558. The front piece 556 includes a front flange 560 located at a front end of the front piece 556, and an externally threaded portion 562 located at a rear end of the front piece 556. The rear piece 558 includes an internally threaded portion 563 at a front end of the rear piece 558, and wrench flats 565 at a rear end of the rear piece 558.

To mount the connecter body 552 within the housing 554, the front piece 556 is inserted through the front end 570 of the housing 554 such that the front flange 560 fits within the front pocket 578 of the housing 554. The rear piece 558 is then inserted through the rear end 572 of the housing 554 and the internally threaded portion 563 is threaded over the externally threaded portion 562. The wrench flats 565 allow the threaded connection to be securely tightened, and the retaining members 576 of the housing 554 engage the flange 560 to prevent rotation of the front piece 556. The flange 560 abuts against the front face of the front wall 575 and the rear piece abuts against the rear face of the front wall 575 to limit or prevent axial movement of the connector body 552 relative to the housing 554.

The connectors disclosed herein is adapted for use in a coaxial system. However, it will be appreciated that the various inventive aspects are applicable to other types of connectors as well. It will be appreciated that many embodiments of the inventions can be made without departing from the spirit and scope of the inventions.

We claim:

1. A telecommunications connector comprising:
a connector body; and
a housing that mounts over the connector body, the housing including a front end and a rear end, the housing also including structure for providing a snap-fit within a mounting opening defined by a piece of telecommunications equipment, the structure including first and second snap-fit elements configured for allowing the housing to be snap fit within the mounting opening by inserting the housing into the mounting opening from either a forward or a rearward direction.

2. The connector of claim 1, wherein the first and second snap-fit elements include first and second ramped tabs separated by a gap.

3. The connector of claim 2, wherein the first and second ramped tabs include ramped surfaces positioned to converge as the ramped surfaces extend toward the gap.

4. The connector of claim 3, wherein the first and second tabs include ramped surfaces that angle away from the housing as the ramped surfaces extend toward the gap.

5. The connector of claim 2, wherein both the first and second tabs are positioned on a single cantilever having a base end integrally formed with the housing.

6. The connector of claim 1, wherein the connector body is adapted for connection to a co-axial connector.

7. A telecommunications connector comprising:
a connector body; and
a housing that mounts over the connector body, the housing including a front end and a rear end, the housing also including a resilient cantilever including front and rear retaining members separated by a gap, the housing being insertable into a mounting opening of a piece of telecommunications equipment from either a forward or a rearward direction.

8. The connector of claim 7, wherein the first and second retaining members include first and second ramped tabs separated by the gap.

9. The connector of claim 8, wherein the first and second ramped tabs include ramped surfaces positioned to converge as the ramped surfaces extend toward the gap.

10. The connector of claim 8, wherein the first and second tabs include ramped surfaces that angle away from the housing as the ramped surfaces extend toward the gap.

11. The connector of claim 7, wherein a base end integrally formed with the housing adjacent the rear end.

12. The connector of claim 11, wherein the front retaining member has a greater height than the rear retaining member.

13. The connector of claim 7, wherein the connector body is adapted for connection to a co-axial connector.

14. A telecommunications connector comprising:
a connector body; and
a housing that mounts over the connector body, the housing including a front end and a rear end, the housing also including a resilient cantilevers positioned at opposite sides of the housing, the cantilevers having base ends integrally connected to the housing adjacent the rear end of the housing and free ends positioned adjacent the front end of the housing, each cantilever including front and rear tabs separated by a gap, the front and rear tabs having ramp surfaces that angle away from the housing as the ramp surfaces extend toward the gap, the housing being insertable into a mounting opening of a piece of telecommunications equipment from either a forward or a rearward direction.
